(19) United States
(12) Patent Application Publication
(10) Pub. No.: US 2025/0056682 A1
(43) Pub. Date: Feb. 13, 2025

(54) FILM HEATER

(71) Applicant: DENSO CORPORATION, Kariya-city (JP)

(72) Inventors: Taro OGURA, Kariya-city (JP); Fuminobu MIKAMI, Kariya-city (JP); Takahito NAKAMURA, Kariya-city (JP)

(21) Appl. No.: 18/929,916

(22) Filed: Oct. 29, 2024

Related U.S. Application Data
(63) Continuation of application No. PCT/JP2023/018140, filed on May 15, 2023.

(30) Foreign Application Priority Data
May 16, 2022 (JP) 2022-080246
Nov. 28, 2022 (JP) 2022-189292

(51) Int. Cl. H05B 3/84; F21S 45/60; H05B 1/02

(52) U.S. Cl. CPC H05B 3/84; F21S 45/60; H05B 1/0205; H05B 2203/013

(57) ABSTRACT

A film heater is to be attached to an object to be heated. The film heater includes a conductive film that generates heat when supplied with electricity, and a pair of electrode sections connected to the conductive film. A structure including the conductive film and the pair of electrode sections includes an attached portion that is to be attached to the object to be heated, and a separated portion that is connected to the attached portion and is to be spaced part from the object to be heated. The separated portion includes a disconnection portion that melts or breaks in response to an occurrence of overcurrent.

### CROSS REFERENCE TO RELATED APPLICATIONS

The present application is a continuation application of International Patent Application No. PCT/JP2023/018140 filed on May 15, 2023, which designated the U.S. and claims the benefit of priority from Japanese Patent Application No. 2022-080246 filed on May 16, 2022 and Japanese Patent Application No. 2022-189292 filed on Nov. 28, 2022. The entire disclosures of all of the above applications are incorporated herein by reference.

### TECHNICAL FIELD

The present disclosure relates to a film heater that is attached to an object to be heated.

### BACKGROUND

Conventionally, there has been known a film heater that heats a headlamp cover through which light passes.

### SUMMARY

The present disclosure provides a film heater to be attached to an object to be heated, and the film heater includes a conductive film that generates heat when supplied with electricity, and a pair of electrode sections connected to the conductive film. A structure including the conductive film and the pair of electrode sections includes an attached portion that is to be attached to the object to be heated, and a separated portion that is connected to the attached portion and is to be spaced part from the object to be heated. The separated portion includes a disconnection portion that melts or breaks in response to an occurrence of overcurrent.

### BRIEF DESCRIPTION OF DRAWINGS

Objects, features and advantages of the present disclosure will become apparent from the following detailed description made with reference to the accompanying drawings. In the drawings:

FIG. 1 is a front view of a vehicle to which a film heater according to a first embodiment is applied;

FIG. 2 is a configuration diagram of a heater system including the film heater according to the first embodiment;

FIG. 3 is a cross-sectional view taken along line III-III in FIG. 2;

FIG. 4 is an explanatory diagram for explaining how a current flows in the film heater when an unintentional short circuit occurs;

FIG. 5 is an explanatory diagram for explaining the film heater when an overcurrent flows;

FIG. 6 is a diagram for explaining electrical resistance at an attached electrode portion and a separated electrode portion of a film heater according to a second embodiment;

FIG. 7 is a front view showing a portion of the film heater according to the second embodiment;

FIG. 8 is a cross-sectional view taken along line VIII-VIII in FIG. 7;

FIG. 9 is a front view showing a portion of a film heater according to a third embodiment;

FIG. 10 is a front view showing a portion of a film heater according to a modification of the third embodiment;

FIG. 11 is a front view showing a portion of a film heater according to a fourth embodiment;

FIG. 12 is a diagram for explaining electrical conductivity at a disconnection portion and the other portion;

FIG. 13 is a diagram for explaining the amount of heat transfer at an attached electrode portion and a separated electrode portion of a film heater according to a fifth embodiment;

FIG. 14 is an explanatory diagram for explaining surface roughness at the attached electrode portion and the separated electrode portion;

FIG. 15 is a schematic cross-sectional view of a film heater according to a sixth embodiment;

FIG. 16 is an explanatory diagram for explaining flow velocity of airflow around the attached electrode portion and the separated electrode portion;

FIG. 17 is an explanatory diagram for explaining thermal conductivities of materials constituting an attached electrode portion and a separated electrode portion of a film heater according to a seventh embodiment;

FIG. 18 is an explanatory diagram for explaining thermal conductivities of materials constituting an attached insulating portion and a separated insulating portion of a film heater according to an eighth embodiment;

FIG. 19 is an explanatory diagram for explaining linear expansion coefficients of materials constituting an attached insulating portion and a separated insulating portion of the film heater according to a ninth embodiment;

FIG. 20 is a schematic cross-sectional view of a film heater according to a tenth embodiment;

FIG. 21 is a schematic cross-sectional view of a film heater according to an eleventh embodiment;

FIG. 22 is a schematic cross-sectional view of a film heater according to a twelfth embodiment;

FIG. 23 is a schematic cross-sectional view of a film heater according to a modification of the twelfth embodiment;

FIG. 24 is a schematic cross-sectional view of a film heater according to a thirteenth embodiment;

FIG. 25 is a schematic cross-sectional view of a film heater according to a first modification of the thirteenth embodiment;

FIG. 26 is a schematic cross-sectional view of a film heater according to a second modification of the thirteenth embodiment;

FIG. 27 is a configuration diagram of a heater system including a film heater according to a fourteenth embodiment; and

FIG. 28 is a cross-sectional view taken along line XXVIII-XXVIII in FIG. 27.

### DETAILED DESCRIPTION

Next, a relevant technology is described only for understanding the following embodiments. A control unit of a film heater may be provided with a protection circuit including a current fuse that melts in response to an occurrence of overcurrent.

However, when a current fuse that melts in response to an occurrence of overcurrent is provided in a protection circuit for a control circuit, the number of components increases, resulting in increased costs.

According to one aspect of the present disclosure, a film heater is to be attached to an object to be heated, and includes a conductive film that generates heat when supplied with electricity, and a pair of electrode sections connected to the conductive film. A structure including the conductive film and the pair of electrode sections includes an attached portion that is to be attached to the object to be heated, and a separated portion that is connected to the attached portion and is to be spaced part from the object to be heated. The separated portion includes a disconnection portion that melts or breaks in response to an occurrence of overcurrent.

When a film heater has portions spaced apart from an object to be heated, heat generated in a pair of electrode sections located at the portions is difficult to transfer heat to the object to be heated. For this reason, the portions separated from the object to be heated tend to have a higher temperature than portions of the pair of electrode sections that are in contact with the object to be heated.

Taking this into consideration, the film heater of the present disclosure includes the separated portion, which is spaced apart from the object to be heated, in the structure including the conductive film and the pair of electrode sections. If the separated portion is used as the disconnection portion that melts or breaks in response to an occurrence of overcurrent, it is possible to provide protection against overcurrent while restricting an increase in the number of components.

Hereinafter, embodiments of the present disclosure will be described with reference to the drawings. In the following embodiments, parts that are the same as or equivalent to parts described in the preceding embodiment are denoted by the same reference numerals, and description thereof may be omitted. When only a part of components is described in the embodiment, components described in the preceding embodiment can be applied to other parts of the components. The following embodiments may be partially combined with each other even if such a combination is not explicitly described as long as there is no disadvantage with respect to such a combination.

### First Embodiment

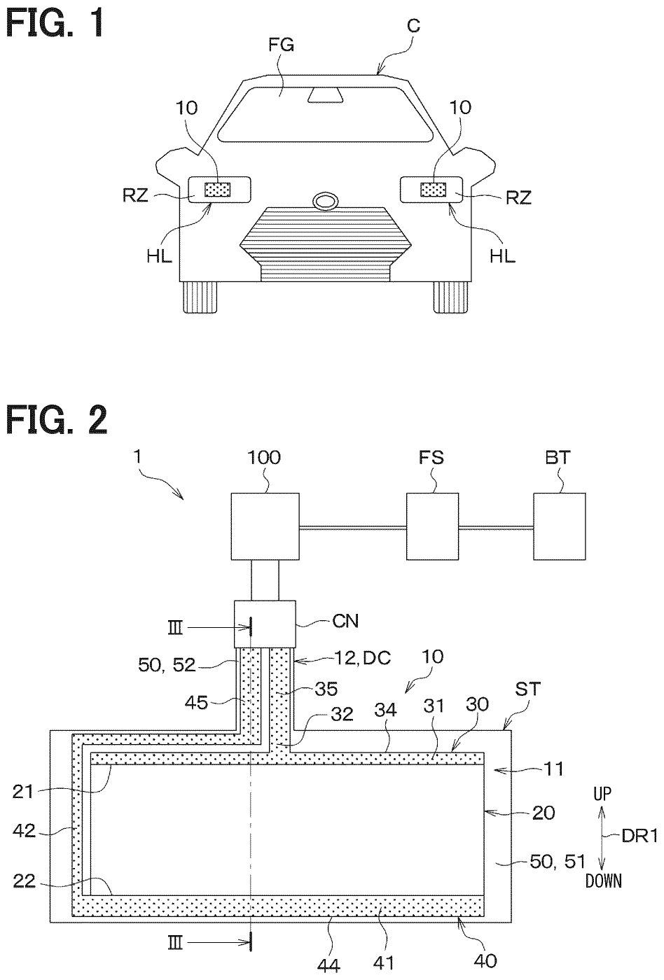

The present embodiment will be described with reference to FIGS. 1 to 5. In the present embodiment, an example in which the film heater 10 of the present disclosure is applied to headlights HL, which are headlights of a vehicle C, will be described. In the present embodiment, the headlights HL are “objects to be heated” of the film heater 10. The headlights HL are transparent light-transmitting members that transmit electromagnetic waves (visible light in the present example).

Here, the headlights HL are configured as LED lamps in which LEDs are used as light sources. Compared with halogen lamps, LED lamps emit less infrared light and lens portions RZ doe not heat up easily, so if snow or ice adheres to the lens portions RZ, it does not melt easily. These are undesirable since they cause a decrease in the illuminance of the headlights HL.

Taking this into consideration, in the present embodiment, the film heater 10 is applied to the headlights HL. The film heater 10 constitutes a part of a heater system 1. The film heater 10 is made of an optically adhesive sheet, and is attached to the lens portion RZ of the headlight HL as shown in FIG. 1. The film heater 10 generates heat to heat the lens portion RZ of the headlight HL, thereby melting ice, snow, preventing fogging, and the like, of the lens portion RZ. This ensures sufficient illuminance for the headlight HL, thereby improving safety when the vehicle C is traveling.

As shown in FIG. 2, the heater system 1 includes the film heater 10 and a control unit 100. Up-down arrows shown in FIG. 2 and the like indicate an up-down direction DR1 of the film heater 10 when the film heater 10 is attached to the lens portion RZ of the headlight HL.

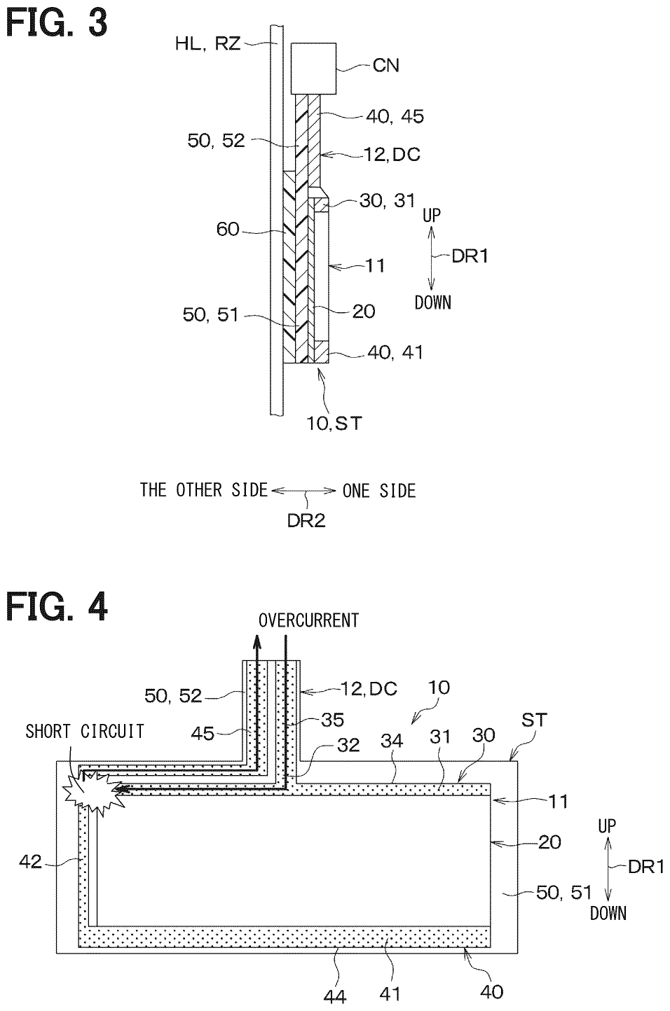

The film heater 10 is a heater formed in a film shape. As shown in FIG. 3, the film heater 10 includes a conductive film 20, a first electrode section 30, a second electrode section 40, an insulating section 50, and a support member 60.

The insulating section 50 is a member that serves as a base member of the film heater 10. The insulating section 50 is a transparent thin film having electrical insulation properties. The insulating section 50 is made of a thermoplastic resin such as polycarbonate. The insulating section 50 has a thickness of, for example, about 0.05 to 0.5 mm. In the present embodiment, the insulating section 50 constitutes a base member that supports at least one of the conductive film 20 and a pair of electrode sections 30, 40.

The conductive film 20 is a heat generating portion that generates heat when electricity is applied thereto. The conductive film 20 is a transparent thin film that is electrically conductive. The conductive film 20 is laminated on one surface of the insulating section 50.

The conductive film 20 is formed of, for example, ITO or a carbon tube. ITO is an abbreviation for Indium-Tin-Oxide. The conductive film 20 has a smaller thickness than the insulating section 50. The conductive film 20 has a thickness of a few nanometers. The resistivity of the conductive film 20 may be uniform within a plane, or may be uneven and biased. The conductive film 20 described above is configured so that current flows therethrough in a planar manner rather than linearly.

The first electrode section 30 and the second electrode section 40 are a pair of electrode sections electrically connected to the conductive film 20. The first electrode section 30 and the second electrode section 40 are laminated on surfaces of the conductive film 20 and the insulating section 50.

The first electrode section 30 and the second electrode section 40 are electrically connected via the conductive film 20. The first electrode section 30 and the second electrode section 40 may be formed, for example, by printing silver paste or copper paste on the conductive film 20 and firing it. The first electrode section 30 and the second electrode section 40 are electrically conductive with the conductive film 20 at the portions where they are in physical contact with the conductive film 20.

The resistivities of the first electrode section 30 and the second electrode section 40 are sufficiently smaller than the resistivity of the conductive film 20. In other words, the electrical conductivities of the first electrode section 30 and the second electrode section 40 are sufficiently greater than the electrical conductivity of the conductive film 20. For example, the average electrical conductivity of the first electrode section 30 and the second electrode section 40 is 10 times or more the average electrical conductivity of the conductive film 20. Moreover, the first electrode section 30 and the second electrode section 40 are thicker than the conductive film 20 and thinner than the insulating section 50. The first electrode section 30 and the second electrode section 40 each have a thickness of, for example, approximately several microns.

The first electrode section 30 is connected to an upper edge portion 21 on an upper side of the conductive film 20. The first electrode section 30 has a first contact portion 31 that is in physical contact with the conductive film 20 and a first lead portion 32 that connects the first contact portion 31 to a connector CN. In the first electrode section 30, the first contact portion 31 extends in a direction intersecting the up-down direction DR1, and the first lead portion 32 extends vertically in a straight line 1 so as to intersect with the first contact portion 31.

The second electrode section 40 is connected to a lower edge portion 22 located on a lower side of the conductive film 20. The second electrode section 40 has a second contact portion 41 that is in physical contact with the conductive film 20 and a second lead portion 42 that connects the second contact portion 41 to the connector CN.

The second contact portion 41 of the second electrode section 40 extends in the direction intersecting the up-down direction DR1. The second lead portion 42 has a first portion that extends vertically in a straight line on a side of the conductive film 20 from a portion that is in contact the second contact portion 41, a second portion that intersects the first portion and extends along the first contact portion 31 of the first electrode section 30, and a portion that intersects the second portion and extends vertically in a straight line.

A structure including the conductive film 20, the pair of electrode sections 30, 40, and the insulating section 50 configured as described above is configured as a laminated body ST in which the conductive film 20, the pair of electrode sections 30, 40, and the insulating section 50 are laminated in a predetermined order. The laminated body ST is obtained, for example, by forming the conductive film 20 of a predetermined shape on the insulating section 50 serving as the base member using a screen mask, and then forming the pair of electrode sections 30, 40 of a predetermined pattern. Arrows indicating one side and the other side shown in FIG. 3 and the like indicate a lamination direction DR2 of the laminated body ST. In the present embodiment, a side of the laminated body ST on which the pair of electrode sections 30, 40 are disposed is defined as one side, and a side of the laminated body ST on which the insulating section 50 is disposed is defined as the other side. In the front view of FIG. 2 and the like, the pair of electrode sections 30, 40 are drawn with a dot pattern in order to distinguish them from the others components. In the actual product, the pair of electrode sections 30, 40 are not provided with the dot pattern.

The laminated body ST is formed in a film or sheet shape, and overall, the laminated body ST has a small thickness in the lamination direction DR2. The laminated body ST includes a main body portion 11 of substantially rectangular shape and a connector connection portion 12 extending upward from the main body portion 11.

The main body portion 11 includes the conductive film 20, the pair of electrode sections 30, 40, and the insulating section 50. The main body portion 11 includes the conductive film 20 and functions as a heat generating portion that generates heat when electricity is applied thereto. The main body portion 11 is attached to the lens portion RZ via the support member 60 so that heat from the main body portion 11 is efficiently transferred to the lens portion RZ. Specifically, the other side of the laminated body ST in the lamination direction DR2 is attached to the lens portion RZ by the support member 60.

The support member 60 is in the form of a film or sheet, and for example, an optical adhesive such as OCR or OCA having excellent light transmittance is adopted. OCR is an abbreviation for “Optical Clear Resin”. OCA is an abbreviation for “Optical Clear Adhesive”. In the present embodiment, the support member 60 constitutes a support member that supports at least one of the conductive film 20 and the pair of electrode sections 30, 40.

The connector connection portion 12 includes the pair of electrode sections 30, 40 and the insulating section 50. The connector connection portion 12 does not include the conductive film 20 and functions as a power supply portion that supplies power to the conductive film 20. The connector CN for electrically connecting the laminated body ST of the film heater 10 to the control unit 100 is attached to an upper end portion of the connector connection portion 12. The connector connection portion 12 may include not only the pair of electrode sections 30, 40 and the insulating section 50, but also the conductive film 20.

The connector connection portion 12 is spaced apart from the lens portion RZ, with no support member 60 provided between the connector connection portion 12 and the lens portion RZ. Specifically, the other side of the laminated body ST in the lamination direction DR2 is attached to the lens portion RZ by the support member 60. In the laminated body ST of the present embodiment, the main body portion 11 forms an “attached portion” that is attached to an object to be heated, and the connector connection portion 12 forms a “separated portion” that is spaced apart from the object to be heated.

In the present embodiment, the first electrode section 30 and the second electrode section 40 located in the main body portion 11 are defined as a first attached electrode portion 34 and a second attached electrode portion 44, and the first electrode section 30 and the second electrode section 40 located in the connector connection portion 12 are defined as a first separated electrode portion 35 and a second separated electrode portion 45. The insulating section 50 located in the main body portion 11 is defined as an attached insulating portion 51, and the insulating section 50 located in the connector connection portion 12 is defined as a separated insulating portion 52.

In the film heater 10 configured in this manner, the connector connection portion 12 is separated from the lens portion RZ, so that heat generated at the first separated electrode portion 35 and the second separated electrode portion 45 located in the connector connection portion 12 is unlikely to transfer to the lens portion RZ. For this reason, the first separated electrode portion 35 and the second separated electrode portion 45 tend to reach a higher temperature than the first attached electrode portion 34 and the second attached electrode portion 44.

Taking these factors into consideration, in the film heater 10, the connector connection portion 12 functions as a disconnection portion DC that melts or breaks in response to an occurrence of overcurrent. In addition, the electrical resistance value and the like of each of the separated electrode portions 35, 45 of the connector connection portion 12 is set so that when an overcurrent occurs, a temperature of the separated insulating portion 52 exceeds a melting point of the separated insulating portion 52 due to Joule heat generated at the first separated electrode portion 35 and the second separated electrode portion 45.

Returning to FIG. 2, the film heater 10 is connected to the control unit 100 via the connector CN. The control unit 100 controls the state and amount of electricity supplied to the film heater 10. The control unit 100 is connected to a vehicle battery BT via a current fuse FS. The current fuse FS melts in response to an occurrence of overcurrent between the vehicle battery BT and the control unit 100, thereby protecting in-vehicle devices such as the vehicle battery BT.

Although not shown, the control unit 100 is accommodated inside an equipment accommodation section in the vehicle C that accommodates driving equipment for running the vehicle. The control unit 100 includes a microcomputer including a processor and a memory, and the processor carries out various processes according to programs stored in the memory. It should be noted that the control unit 100 is not provided with a fuse for protecting the film heater 10 and the control unit 100.

For example, when the headlights HL are turned on and a heating requirement condition is met that requires either de-icing, melting snow, or preventing fogging of the lens portion RZ of the headlights HL, the control unit 100 starts supplying electricity to the film heater 10. The heating requirement condition may be, for example, a condition that is met when the outside air temperature detected by the outside air temperature sensor falls to 5° C. or lower.

When electricity is applied to the film heater 10, the conductive film 20 generates heat. Then, the heat of the conductive film 20 is transferred to the lens portion RZ of the headlight HL, causing the temperature of the lens portion RZ to rise. This allows the lens portion RZ to be de-iced, snow-melted, and fog-proof.

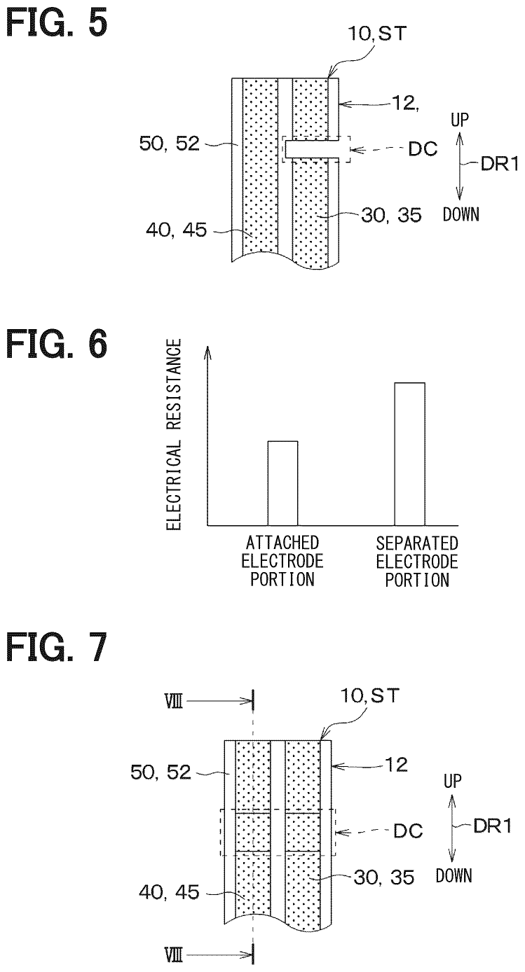

Here, for example, as shown in FIG. 4, if the first electrode section 30 and the second electrode section 40 are short-circuited due to some cause, a current flows from the first electrode section 30 to the second electrode section 40. In this case, the combined resistance of the film heater 10 decreases, causing a larger current (that is, an overcurrent) to flow from the first electrode section 30 to the second electrode section 40. This overcurrent causes a large amount of Joule heat to be generated in the first electrode section 30 and the second electrode section 40. In particular, the temperatures of the separated electrode portions 35, 45 of the electrode sections 30, 40 rise earlier than the attached electrode portions 34, 44 because no heat transfer occurs to the lens portion RZ. When the temperature of each of the separated electrode portions 35, 45 exceeds the melting point of the separated insulating portion 52, a portion of the separated insulating portion 52 melts and deforms. At this time, thermal stress or the like acts on each of the separated electrode portions 35, 45, causing a portion of the separated electrode portions 35, 45 to break, for example, as shown in FIG. 5.

In the film heater 10 described above, the connector connection portion 12 of the laminated body ST is spaced apart from the lens portion RZ, which is the object to be heated. The connector connection portion 12 serves as the disconnection portion DC that melts or breaks in response to an occurrence of overcurrent. In this way, by providing a portion that is weak against heat in the film heater 10 and designating this portion as the disconnection portion DC that melts or breaks in response to an occurrence of overcurrent, it is possible to achieve protection against overcurrent without increasing the number of components.

In addition, the film heater 10 has the following features.

The structure including the conductive film 20 and the pair of electrode sections 30, 40 includes the support member 60 that supports at least one of the conductive film 20 and the pair of electrode sections 30, 40. In the film heater 10 configured in this manner, the support member 60 can improve the workability of attachment to the lens portion RZ, and the support member 60 can reinforce the conductive film 20 and the pair of electrode sections 30, 40.

The connector connection portion 12 is disposed above the main body portion 11 which constitutes the heat generating portion. In this way, if the connector connection portion 12 is positioned above the main body portion 11, the surrounding heat heated by the main body portion 11 rises toward the vicinity of the connector connection portion 12, making it easier for the connector connection portion 12 to heat up quickly. Therefore, in response to an occurrence of overcurrent, the separated electrode portions 35, 45 located in the connector connection portion 12 can appropriately melt or break.

The object to be heated in the present embodiment is the lens portion RZ of the headlight HL, which is transparent and transmits electromagnetic waves. The conductive film 20 is made of a transparent conductive film that transmits electromagnetic waves. The insulating section 50 is made of a transparent insulating material that transmits electromagnetic waves. The film heater 10 configured in this manner can appropriately heat the object to be heated while minimizing the effect on the functionality and design of the object to be heated.

The insulating section 50 has the attached insulating portion 51 located in the main body portion 11 and the separated insulating portion 52 located in the connector connection portion 12. The separated insulating portion 52 has a thickness of 0.05 mm to 0.5 mm in the lamination direction DR2 of the laminated body ST. In this way, by reducing the thickness of the separated insulating portion 52, the thermal capacity is reduced, and the separated insulating portion 52 is more likely to heat up quickly in response to an occurrence of overcurrent, so that portions of the electrode sections 30, 40 located adjacent to the separated insulating portion 52 can properly break in response to an occurrence of overcurrent.

The insulating section 50 is made of a thermoplastic material. According to this feature, in response to an occurrence of overcurrent, the separated insulating portion 52 becomes easily deformed by Joule heat of the separated electrode portions 35, 45. Therefore, a portion of each of the separated electrode portions 35, 45 easily breaks due to thermal stress or the like generated in each of the separated electrode portions 35, 45.

### Modifications of First Embodiment

In the first embodiment of the film heater 10, an overcurrent causes a portion of the separated insulating portion 52 to melt and deform, and at this time, thermal stress or the like acts on each of the separated electrode portions 35, 45, causing a portion of the separated electrode portions 35, 45 to break, as described above, but the present disclosure is not limited to this example. The film heater 10 may be configured such that, for example, a portion of each of the separated electrode portions 35, 45 melts due to Joule heat generated in each of the separated electrode portions 35, 45 due to an overcurrent. The same also applies to the following embodiments.

In the first embodiment, the disconnection portion DC is provided in the film heater 10 instead of a current fuse of the control unit 100, but the heater system 1 is not limited to this example. The heater system 1 may be configured, for example, such that the disconnection portion DC is provided in the film heater 10 and a current fuse is provided in the control unit 100. According to this configuration, it is possible to provide redundant protection functions against overcurrent while restricting an increase in the number of components.

### Second Embodiment

Next, a second embodiment will be described with reference to FIGS. 6 to 8. In the present embodiment, differences from the first embodiment will be mainly described.

As shown in FIG. 6, in the film heater 10, the electrical resistance of at least a portion of each of the separated electrode portions 35, 45 is higher than the electrical resistance of each of the attached electrode portions 34, 44. In each of the separated electrode portions 35, 45, the portion having the higher electrical resistance becomes a disconnection portion DC, which melts or breaks in response to an occurrence of overcurrent.

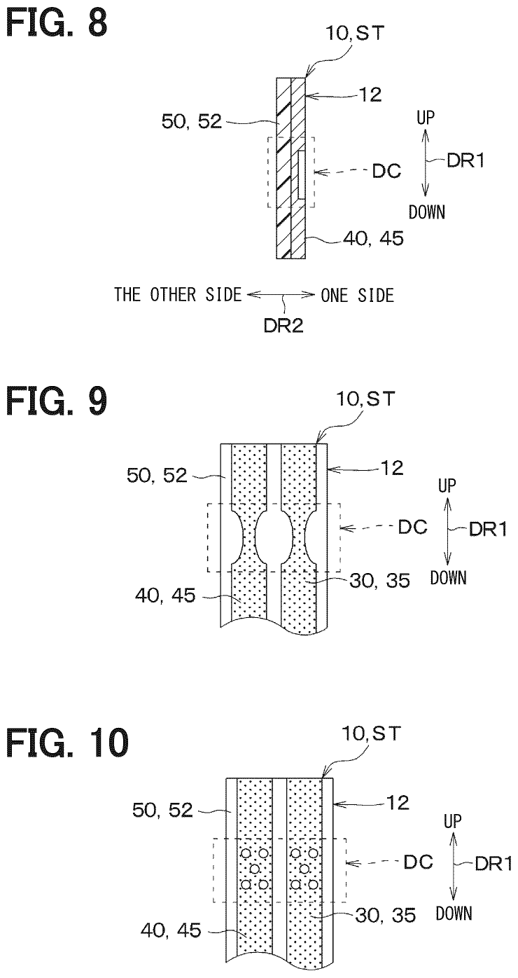

As shown in FIG. 7 and FIG. 8, in each of the electrode sections 30, 40, a cross-sectional area of at least a portion of each of the separated electrode portions 35, 45 that intersects with the direction of current flow is smaller than a cross-sectional area of the other portions. In other words, at least a portion of each of the separated electrode portions 35, 45 has a smaller cross-sectional area intersecting the direction of current flow than the cross-sectional area of each of the attached electrode portions 34, 44. In the present embodiment, current flows vertically in each of the separated electrode portions 35, 45. Therefore, the cross-sectional area of each of the separated electrode portions 35, 45 that intersects with the direction of current flow is the cross-sectional area of each of the separated electrode portions 35, 45 that intersects with the up-down direction DR1.

Specifically, at least a portion of each of the separated electrode portions 35, 45 has a smaller thickness in the lamination direction DR2 of the laminated body ST than the thickness of each of the attached electrode portions 34, 44 in the lamination direction DR2 of the laminated body ST. The thinner portion of each of the separated electrode portions 35, 45 serves as the disconnection portion DC.

The other configurations are the same as those in the first embodiment. The film heater 10 in the present embodiment can achieve the effects obtained from the common configuration or the equivalent configuration to the first embodiment.

The film heater 10 of the present embodiment has the following features.

In the film heater 10, at least a portion of each of the separated electrode portions 35, 45 has a high electrical resistance. According to this feature, Joule heat generated in each of the separated electrode portions 35, 45 becomes large in response to an occurrence of overcurrent, so that in response to the occurrence of overcurrent, each of the separated electrode portions 35, 45 can appropriately melt or break due to thermal distortion that occurs between the separated electrode portions 35, 45 and the surrounding area or overheating.

A cross-sectional area of at least a portion of each of the separated electrode portions 35, 45 that intersects with the direction of current flow is smaller than the cross-sectional area of each of the attached electrode portions 34, 44. In this way, by reducing the thickness in the lamination direction DR2 of at least a portion of each of the separated electrode portions 35, 45, the electrical resistance of each of the separated electrode portions 35, 45 can be made higher than that of each of the attached electrode portions 34, 44 without adding any new components.

Specifically, at least a portion of each of the separated electrode portions 35, 45 has a smaller thickness in the lamination direction DR2 of the laminated body ST than the thickness of each of the attached electrode portions 34, 44 in the lamination direction DR2 of the laminated body ST. In this way, by reducing the thickness in the lamination direction DR2 of at least a portion of each of the separated electrode portions 35, 45, the electrical resistance of each of the separated electrode portions 35, 45 can be made higher than that of each of the attached electrode portions 34, 44 without adding any new components.

### Third Embodiment

Next, a third embodiment will be described with reference to FIG. 9. In the present embodiment, differences from the second embodiment will be mainly described.

As shown in FIG. 9, instead of the thickness in the lamination direction DR2 of each of the separated electrode portions 35, 45, an electrode width of at least a portion of each of the separated electrode portions 35, 45 is set to be narrower than an electrode width of each of the attached electrode portions 34, 44 of the laminated body ST. Of the separated electrode portions 35, 45, the portions with the narrower electrode width are disconnection portions DC. The electrode width is a width dimension of each of the electrode sections 30, 40 in a direction intersecting the direction of current flow.

The other configurations are the same as those in the embodiments described above. The film heater 10 in the present embodiment can achieve the effects obtained from the common configuration or the equivalent configuration to the embodiments described above.

The film heater 10 of the present embodiment has the following features.

The electrode width of at least a portion of each of the separated electrode portions 35, 45 is smaller than the electrode width of each of the attached electrode portions 34, 44. In this way, by reducing the electrode width of at least a portion of each of the separated electrode portions 35, 45, the electrical resistance of each of the separated electrode portions 35, 45 can be made larger than that of each of the attached electrode portions 34, 44 without adding any new components.

### Modifications of Third Embodiment

In the third embodiment, the electrode width of at least a portion of each of the separated electrode portions 35, 45 is smaller than the electrode width of each of the attached electrode portions 34, 44, but the present disclosure is not limited to this example. Each of the separated electrode portions 35, 45 may be configured, for example as shown in FIG. 10, to have one or more non-conductive masked portions so that the cross-sectional area intersecting the direction of current flow is reduced.

In another modification, at least a portion of each of the separated electrode portions 35, 45 in the third embodiment may have a small thickness in the lamination direction DR2. This also makes it possible to reduce the cross-sectional area intersecting the direction of current flow.

### Fourth Embodiment

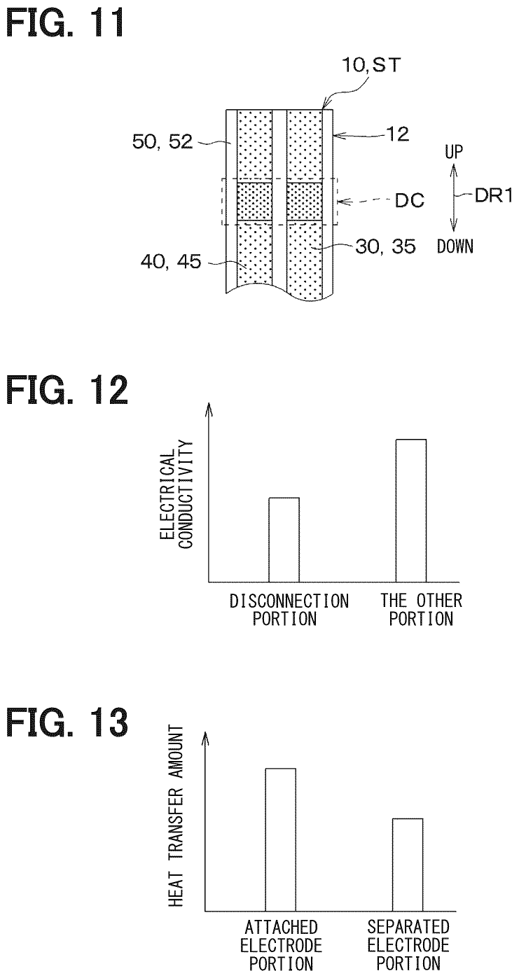

Next, a fourth embodiment will be described with reference to FIGS. 11 and 12. In the present embodiment, differences from the second embodiment will be mainly described.

As shown in FIG. 11, a portion of each of the separated electrode portions 35, 45 has a lower electrical conductivity than the other portion excluding the portion, and is made of a conductive material. In the separate electrode portions 35, 45, the portions made of conductive material having low electrical conductivity become the disconnection portions DC. As shown in FIG. 12, the electrical conductivity of the disconnection portion DC is smaller than that of the other portion. In each of the separated electrode portions 35, 45, for example, the disconnection portion DC is made of aluminum and the other portion is made of copper.

The other configurations are the same as those in the embodiments described above. The film heater 10 in the present embodiment can achieve the effects obtained from the common configuration or the equivalent configuration to the embodiments described above.

The film heater 10 of the present embodiment has the following features.

As in the present embodiment, when a portion of each of the separated electrode portions 35, 45 is made of a conductive material having low electrical conductivity, the electrical resistance of each of the separated electrode portions 35, 45 can be made larger than that of each of the attached electrode portions 34, 44 without adding any new components.

### Fifth Embodiment

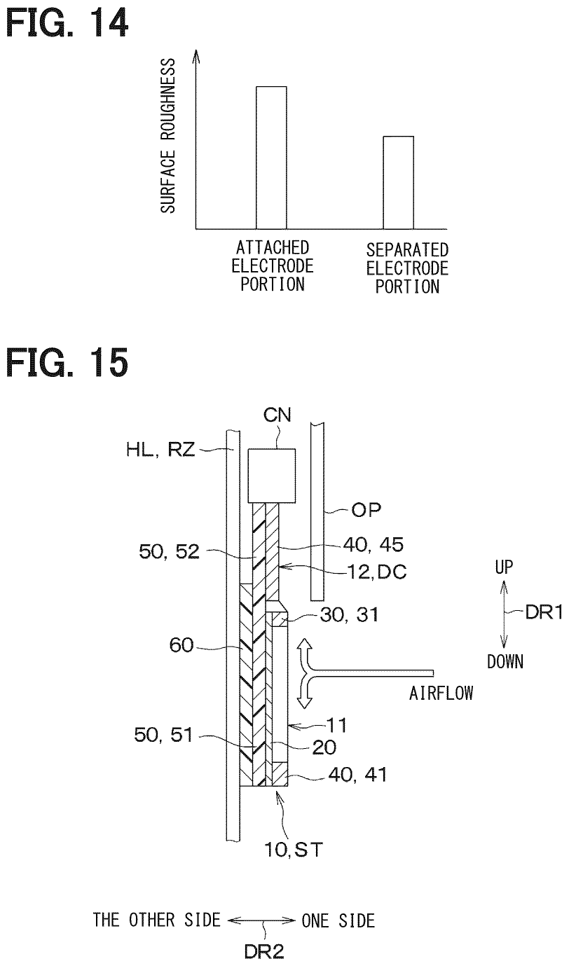

Next, a fifth embodiment will be described with reference to FIGS. 13 and 14. In the present embodiment, differences from the first embodiment will be mainly described.

As shown in FIG. 13, in the film heater 10 of the present embodiment, the amount of heat transfer in at least a portion of each of the separated electrode portions 35, 45 is smaller than the amount of heat transfer in each of the attached electrode portions 34, 44. In the separated electrode portions 35, 45, the portions with the small amount of heat transfer become the disconnection portion DC, which melts or breaks in response to an occurrence of overcurrent. The amount of heat transfer is the amount of heat transferred to the outside in each of the electrode sections 30 and 40.

Specifically, as shown in FIG. 14, at least a portion of each of the separated electrode portions 35, 45 has a surface roughness smaller than that of each of the attached electrode portions 34, 44. As a result, the heat transfer area in each of the separated electrode portions 35, 45 becomes smaller than the heat transfer area in each of the attached electrode portions 34, 44, and the amount of heat transfer of each of the separated electrode portions 35, 45 becomes smaller.

The other configurations are the same as those in the embodiments described above. The film heater 10 in the present embodiment can achieve the effects obtained from the common configuration or the equivalent configuration to the embodiments described above.

The film heater 10 of the present embodiment has the following features.

The film heater 10 is configured such that the amount of heat transfer of at least a portion of each of the separated electrode portions 35, 45 is small. According to this feature, the temperature of each of the separated electrode portions 35, 45 is likely to rise quickly in response to an occurrence of overcurrent, so that each of the separated electrode portions 35, 45 can appropriately melt or break in response to an occurrence of overcurrent.

At least a portion of each of the separated electrode portions 35, 45 has a smaller surface roughness than each of the attached electrode portions 34, 44. This allows the amount of heat transfer of each of the separated electrode portions 35, 45 to be smaller than that of each of the attached electrode portions 34, 44 without adding any new components.

### Sixth Embodiment

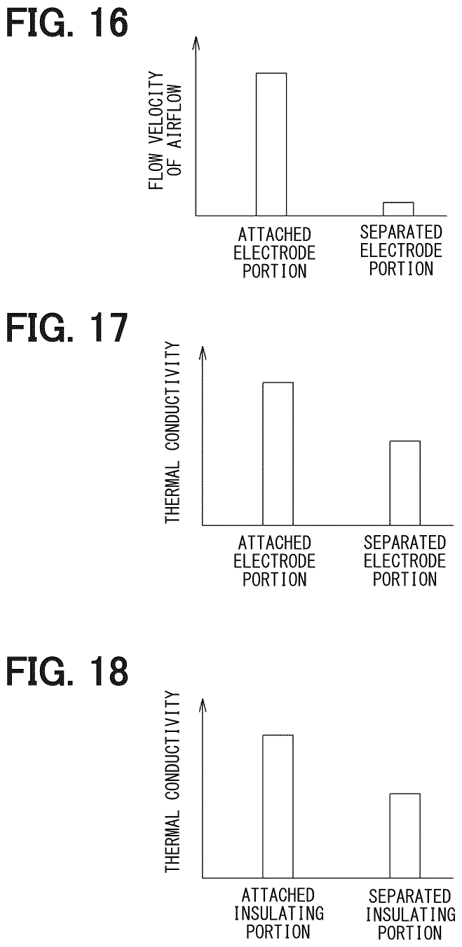

Next, a sixth embodiment will be described with reference to FIGS. 15 and 16. In the present embodiment, differences from the fifth embodiment will be mainly described.

As shown in FIG. 15, in the film heater 10 of the present embodiment, the connector connection portion 12 is disposed inside an outer plate OP of the vehicle C, such as a hood. As a result, the connector connection portion 12 is not exposed to traveling wind of the vehicle C.

By configuring in this manner, at least a portion of each of the separated electrode portions 35, 45 is positioned at a position where the flow velocity of air flowing around the laminated body ST is slower than that in the position where each of the attached electrode portions 34, 44 is disposed. As a result, the flow velocity of the airflow around each of the separated electrode portions 35, 45 becomes smaller than the flow velocity of the airflow around each of the attached electrode portions 34, 44, as shown in FIG. 16, for example. Then, the portion of each of the separated electrode portions 35, 45 that is located at the position where the flow velocity of airflow is small melts or breaks due to the occurrence of overcurrent.

The other configurations are the same as those in the embodiments described above. The film heater 10 in the present embodiment can achieve the effects obtained from the common configuration or the equivalent configuration to the embodiments described above.

The film heater 10 of the present embodiment has the following features.

When the flow velocity of airflow around the laminated body ST is low, the amount of heat transferred to the surrounding of the laminated body ST is small compared to when the flow velocity of airflow is high. At least a portion of each of the separated electrode portions 35, 45 is disposed at the position where the flow velocity of air flowing around the laminated body ST is smaller than the position where each of the attached electrode portions 34, 44 is disposed. In each of the separated electrode portions 35, 45, the portion located at the position where the flow velocity of airflow is small becomes a disconnection portion DC that melts or breaks in response to an occurrence of overcurrent. This allows the amount of heat transfer of each of the separated electrode portions 35, 45 to be smaller than that of each of the attached electrode portions 34, 44 without adding any new components.

### Seventh Embodiment

Next, a seventh embodiment will be described with reference to FIG. 17. In the present embodiment, differences from the first embodiment will be mainly described.

As shown in FIG. 17, in the film heater 10, at least a portion of each of the separated electrode portions 35, 45 is made of a material having a lower thermal conductivity than a material constituting each of the attached electrode portions 34, 44. In each of the separated electrode portions 35, 45, the portion made of the material having the lower thermal conductivity becomes a disconnection portion DC, and melts or breaks in response to an occurrence of overcurrent. For example, in the film heater 10, each of the separated electrode portions 35, 45 is made of aluminum and each of the attached electrode portions 34, 44 is made of copper.

The other configurations are the same as those in the embodiments described above. The film heater 10 in the present embodiment can achieve the effects obtained from the common configuration or the equivalent configuration to the embodiments described above.

The film heater 10 of the present embodiment has the following features.

In the film heater 10, at least a portion of each of the separated electrode portions 35, 45 is made of the material having the low thermal conductivity. According to this feature, in response to an occurrence of overcurrent, heat transfer from each of the separated electrode portions 35, 45 to the surrounding is restricted, making it easier to raise the temperature quickly, so that each of the separated electrode portions 35, 45 can be appropriately melt or break in response to the occurrence of overcurrent.

### Eighth Embodiment

Next, an eighth embodiment will be described with reference to FIG. 18. In the present embodiment, differences from the first embodiment will be mainly described.

As shown in FIG. 18, in the film heater 10, at least a portion of the separated insulating portion 52 is made of a material having a lower thermal conductivity than a material constituting the attached insulating portion 51. A portion of each of the separated electrode portions 35, 35 adjacent to the portion of the separated insulating portion 52 made of the material having the low thermal conductivity becomes a disconnection portion DC, which melts or breaks in response to an occurrence of overcurrent.

The other configurations are the same as those in the embodiments described above. The film heater 10 in the present embodiment can achieve the effects obtained from the common configuration or the equivalent configuration to the embodiments described above.

The film heater 10 of the present embodiment has the following features.

In the film heater 10, at least a portion of the separated insulating portion 52 is made of the material having the low thermal conductivity. This makes it easier for the temperature to rise quickly by restricting heat transfer from the separated insulating portion 52 to the surrounding in response to an occurrence of overcurrent. Therefore, in response to the occurrence of overcurrent, the portions of the pair of electrode sections 30, 40 located adjacent to the separated insulating portion 52 can appropriately melt or break.

### Ninth Embodiment

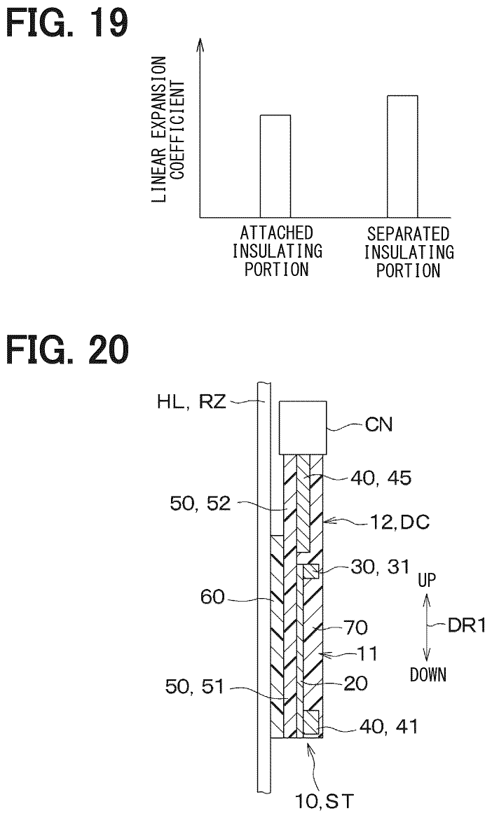

Next, a ninth embodiment will be described with reference to FIG. 19. In the present embodiment, differences from the first embodiment will be mainly described.

As shown in FIG. 19, in the film heater 10, at least a portion of the separated insulating portion 52 is made of a material having a linear expansion coefficient larger than that of a material constituting the attached insulating portion 51. A portion of each of the separated electrode portions 35, 45 adjacent to the portion of the separated insulating portion 52 made of the material having the large linear expansion coefficient becomes a disconnection portion DC, which melts or breaks in response to an occurrence of overcurrent.

The other configurations are the same as those in the embodiments described above. The film heater 10 in the present embodiment can achieve the effects obtained from the common configuration or the equivalent configuration to the embodiments described above.

According to the present embodiment, the following effects can be obtained.

When at least a portion of the separated insulating portion 52 of the film heater 10 is made of the material having a high linear expansion coefficient, thermal stress due to a rise in temperature in response to an occurrence of overcurrent increases. This allows the portions of the pair of electrode sections 30, 40 located adjacent to the separated insulating portion 52 to appropriately melt in response to the occurrence of overcurrent.

### Tenth Embodiment

Next, a tenth embodiment will be described with reference to FIG. 20. In the present embodiment, differences from the first embodiment will be mainly described.

As shown in FIG. 20, the laminated body ST includes a surface layer portion 70 having electrical insulation properties and arranged on the one side in the lamination direction DR2. Specifically, the laminated body ST has a laminated structure in which the conductive film 20 and the pair of electrode sections 30, 40 are sandwiched between the insulating section 50 and the surface layer portion 70 having electrical insulation properties. The surface layer portion 70 may be made of the same material as the insulating section 50, or may be made of a different material from the insulating section 50.

The other configurations are the same as those in the embodiments described above. The film heater 10 in the present embodiment can achieve the effects obtained from the common configuration or the equivalent configuration to the embodiments described above.

The film heater 10 of the present embodiment has the following features.

The laminated body ST constituting the film heater 10 has the laminated structure in which the conductive film 20 and the pair of electrode sections 30, 40 are sandwiched between the insulating section 50 and the surface layer portion 70 having electrical insulation properties. This makes it possible to ensure the electrical insulation properties of the film heater 10 in a simple manner.

### Eleventh Embodiment

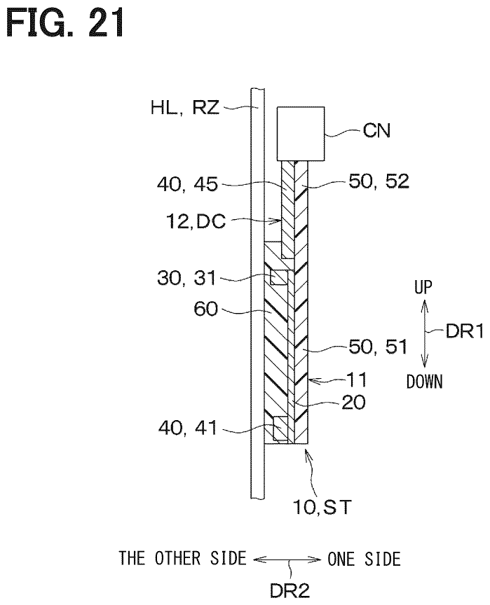

Next, an eleventh embodiment will be described with reference to FIG. 21. In the present embodiment, differences from the first embodiment will be mainly described.

As shown in FIG. 21, the film heater 10 is attached to the lens portion RZ via the support member 60 on the side of each of the electrode sections 30 and 40 in the laminated body ST. That is, the one side of the laminated body ST in the lamination direction DR2 is attached to the lens portion RZ via the support member 60.

The other configurations are the same as those in the embodiments described above. The film heater 10 in the present embodiment can achieve the effects obtained from the common configuration or the equivalent configuration to the embodiments described above.

### Twelfth Embodiment

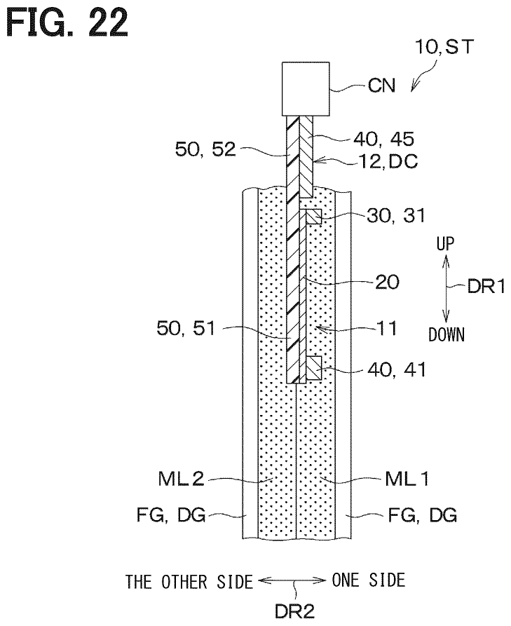

Next, a twelfth embodiment will be described with reference to FIG. 22. In the present embodiment, differences from the first embodiment will be mainly described.

In the present embodiment, an example will be described in which the film heater 10 is attached to a windshield FG, rather than to the lens portion RZ of the headlight HL. The film heater 10 is attached to an object to be heated by inserting the main body portion 11 between two interlayer films ML1, ML2 of a laminated glass DG that constitutes the windshield FG, for example, as shown in FIG. 22. The film heater 10 has the connector connection portion 12 disposed outside the laminated glass DG. The two interlayer films ML are transparent resin films that bond glass pieces of the laminated glass DG together.

The other configurations are the same as those in the embodiments described above. The film heater 10 in the present embodiment can achieve the effects obtained from the common configuration or the equivalent configuration to the embodiments described above.

### Modification of Twelfth Embodiment

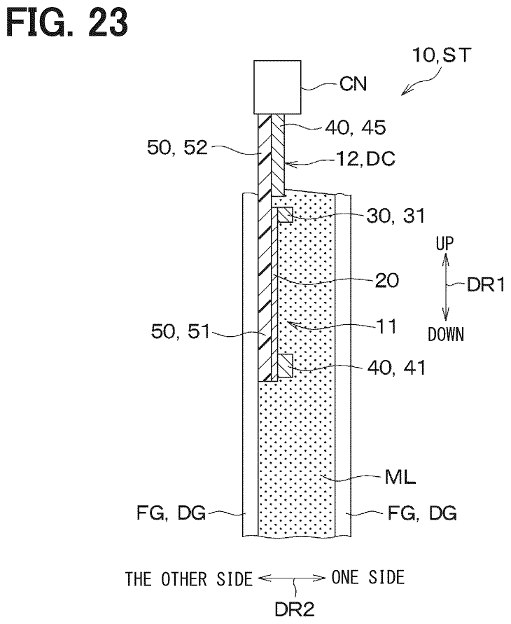

The film heater 10 of the twelfth embodiment is attached to the object to be heated by inserting the main body portion 11 between the two interlayer films ML1, ML2 of the laminated glass DG, but the present disclosure is not limited to this example. The film heater 10 may be attached to the object to be heated, for example, by inserting the main body portion 11 along one inner surface of the laminated glass DG, as shown in FIG. 23.

### Thirteenth Embodiment

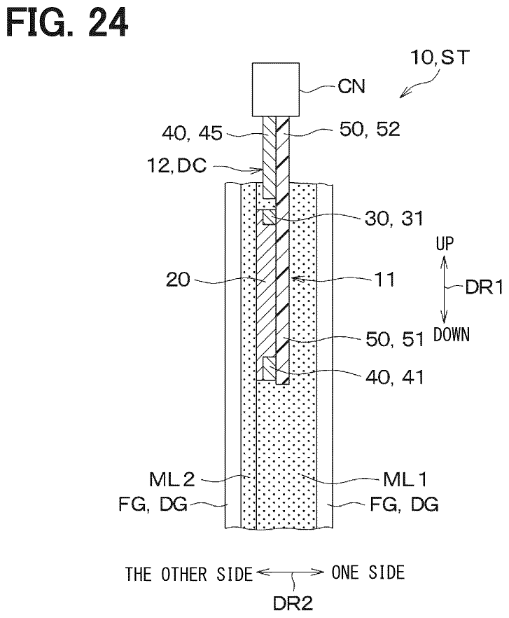

Next, a thirteenth embodiment will be described with reference to FIG. 24. In the present embodiment, differences from the twelfth embodiment will be mainly described.

The film heater 10 has a structure in which the pair of electrode sections 30, 40 laminated on the insulating section 50 are pressed against the conductive film 20 laminated on one of two interlayer films ML1, ML2, as shown in FIG. 24, for example. Such a structure can be obtained, for example, during the manufacture of the laminated glass DG, by laminating the conductive film 20 on one of the two interlayer films ML1, ML2, and bringing the pair of electrode units 30, 40 laminated on the insulating unit 50 into contact with the conductive film 20. The film heater 10 has the connector connection portion 12 disposed outside the laminated glass DG.

The other configurations are the same as those in the embodiments described above. The film heater 10 in the present embodiment can achieve the effects obtained from the common configuration or the equivalent configuration to the embodiments described above.

### Modifications of Thirteenth Embodiment

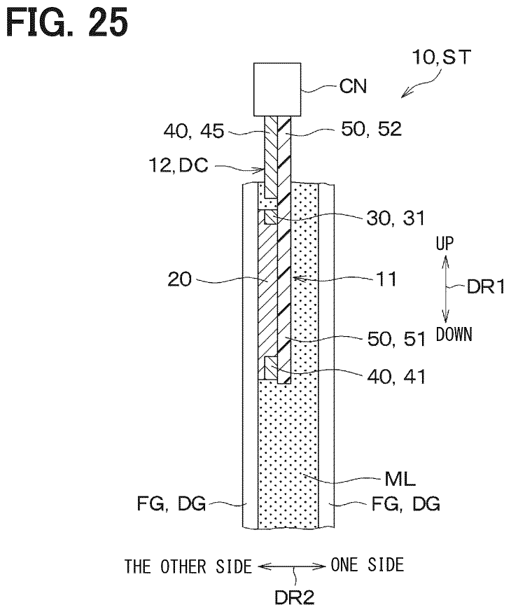

In the film heater 10 of the thirteenth embodiment, the conductive film 20 is laminated on one of the two interlayer films ML1, ML2, but the present disclosure is not limited to this example. The film heater 10 may have a structure in which the pair of electrode sections 30, 40 laminated on the insulating section 50 are pressed against the conductive film 20 laminated on the laminated glass DG, as shown in FIG. 25, for example.

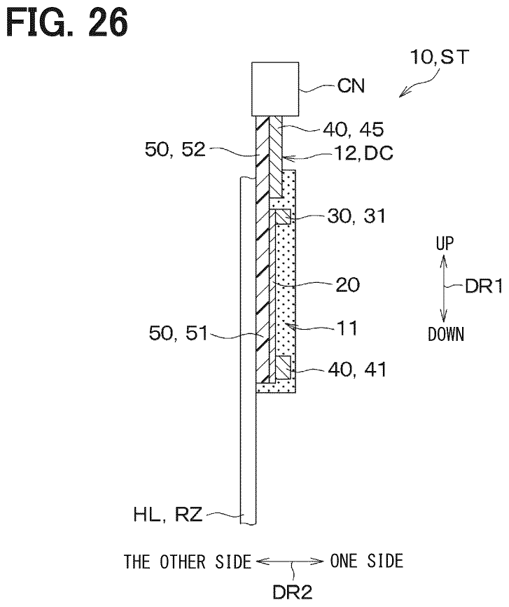

Furthermore, the film heater 10 may be protected by, for example, modulating a part of the laminated body ST with a resin adhesive or the like, as shown in FIG. 26. Note that, in the film heater 10, the entire laminated body ST may be modulated with a resin adhesive or the like.

### Fourteenth Embodiment

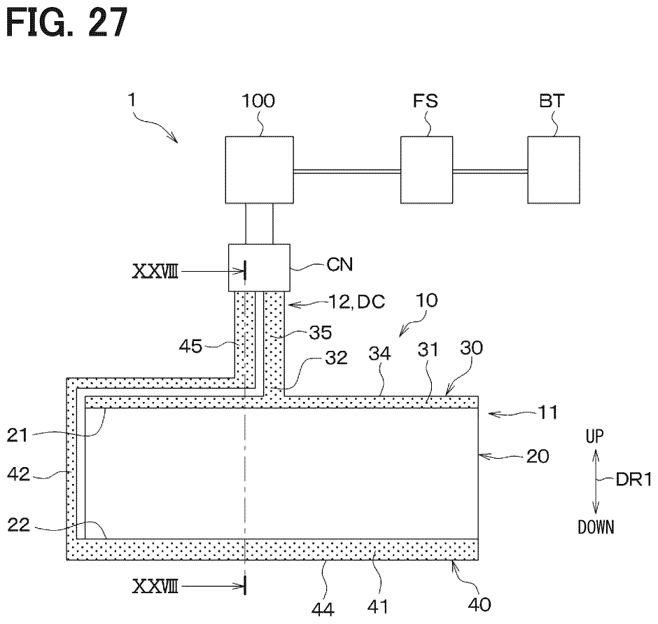

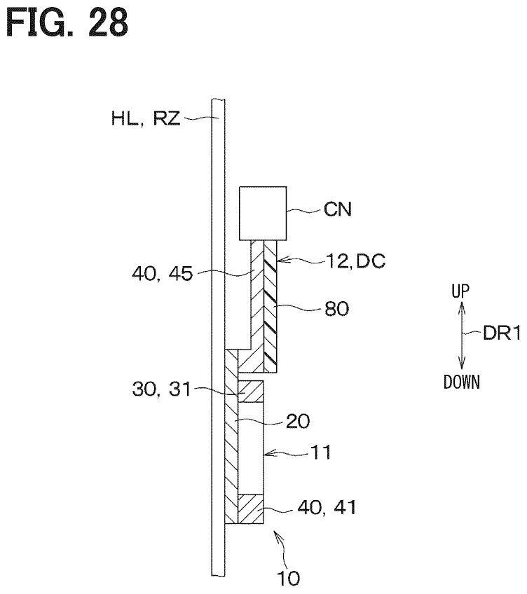

Next, a fourteenth embodiment will be described with reference to FIG. 27 and FIG. 28. In the present embodiment, differences from the first embodiment will be mainly described.

As shown in FIG. 27 and FIG. 28, the film heater 10 includes the conductive film 20, the first electrode section 30, the second electrode section 40, and a support body 80. The film heater 10 of the present embodiment does not include the insulating section 50 described in the first embodiment.

The film heater 10 has the conductive film 20 attached to the headlight HL by an adhesive or the like (not shown). That is, the film heater 10 is attached to the headlight HL directly through the conductive film 20 without the support member 60 therebetween.

The first electrode section 30 and the second electrode section 40 have the first attached electrode portion 34 and the second attached electrode portion 44 that constitute the main body portion 11 and are attached to the headlight HL via the conductive film 20. Furthermore, the first electrode section 30 and the second electrode section 40 have the first separated electrode portion 35 and the second separated electrode portion 45 which constitute the connector connection portion 12 and are separated from the headlight HL. The first separated electrode portion 35 and the second separated electrode portion 45 are attached with the support body 80. The support body 80 is a base member that supports at least one of the conductive film 20 and the pair of electrode sections 30, 40. The support body 80 reinforces the first separated electrode portion 35 and the second separated electrode portion 45. The support body 80 is made of a transparent resin material. The support body 80 is made of, for example, a thermoplastic resin such as polycarbonate. The support body 80 has a thickness of, for example, about 0.05 to 0.5 mm.

The film heater 10 of the present embodiment is not entirely configured as the laminated body ST. Specifically, a structure including the conductive film 20, the first electrode section 30, and the second electrode section 40 is not laminated in the connector connection portion 12.

The other configurations are the same as those in the embodiments described above. The film heater 10 in the present embodiment can achieve the effects obtained from the common configuration or the equivalent configuration to the embodiments described above.

In addition, the film heater 10 has the following features.

The structure including the conductive film 20 and the pair of electrode sections 30, 40 includes the support body 80 that supports at least one of the conductive film 20 and the pair of electrode sections 30, 40. In the film heater 10 configured in this manner, the conductive film 20 and the pair of electrode sections 30, 40 can be reinforced by the support body 80.

### Modifications of Fourteenth Embodiment

In the film heater 10 described in the fourteenth embodiment, the insulating section 50 is omitted, but the present disclosure is not limited to this example and the insulating section 50 may be provided. In the film heater 10 described in the fourteenth embodiment, the conductive film 20 is directly attached to the headlight HL, but the present disclosure is not limited to this example. The film heater 10 may be configured such that the conductive film 20 is attached to the headlight HL via the support member 60, for example.

### Other Embodiments

Although representative embodiments of the present disclosure have been described above, the present disclosure is not limited to the embodiments described above, and various modifications can be made, for example, as follows.

In the above-described embodiments, examples have been described in which the lens portion RZ of the headlight HL of the vehicle C is heated by the film heater 10, but the object to be heated by the film heater 10 is not limited to the headlight HL. The film heater 10 may be applied to a camera, a radar device, a LiDAR, and glass mounted on the vehicle C, in addition to the headlight HL. Furthermore, the film heater 10 can also be applied to moving objects other than the vehicle C, stationary equipment, houses, and the like.

In the above-described embodiments, the film heater 10 is attached to a transparent member that transmits electromagnetic waves such as visible light, but the film heater 10 may be attached to, for example, an opaque member.

In the film heater 10 of the above-described embodiments, the conductive film 20 and the insulating section 50 are made of transparent thin films, but the present disclosure is not limited to this example. A least one of the conductive film 20 and the insulating section 50 may be made of an opaque thin film. The film heater 10 does not have to be configured as the laminated body ST. In the film heater 10, the insulating section 50 having electrical insulation properties is used as the base material, but the present disclosure is not limited to this example. For example, a film-like member having electrical conductivity may be used as a base member.

As in the above-described embodiments, it is desirable that the connector connection portion 12 of the film heater 10 be disposed above the main body portion 11 that constitutes the heat generating portion. However, the present disclosure is not limited to this example, and the connector connection portion 12 does not have to be disposed above the main body portion 11.

In the above-described embodiments, it is needless to say that the elements constituting the embodiments are not necessarily essential unless otherwise specified as being essential in particular or and obviously essential in principle.

In the above-described embodiments, when a numerical value such as the number, a numerical value, an amount, or a range of the constituent elements of the embodiments is mentioned, the numerical value is not limited to the specific number unless otherwise specified as being essential in particular and obviously limited to the specific number in principle.

In the above-described embodiments, when the shapes, positional relationships, and the like of the constituent elements and the like are mentioned, the shapes, positional relationships, and the like are not limited to those mentioned unless otherwise specified and limited to specific shapes, positional relationships, and the like in principle.

What is claimed is:

1. A film heater to be attached to an object to be heated, comprising:
a conductive film that generates heat when supplied with electricity; and
a pair of electrode sections connected to the conductive film, wherein
a structure including the conductive film and the pair of electrode sections includes an attached portion that is to be attached to the object to be heated, and a separated portion that is connected to the attached portion and is to be spaced part from the object to be heated, and
the separated portion includes a disconnection portion that melts or breaks in response to an occurrence of overcurrent.

2. The film heater according to claim 1, wherein
the structure includes a base member that supports at least one of the conductive film and the pair of electrode sections.

3. The film heater according to claim 1, wherein
the pair of electrode sections includes an attached electrode portion located in the attached portion and a separated electrode portion located in the separated portion,
at least a portion of the separated electrode portion has a higher electrical resistance than the attached electrode portion, and
the portion of the separated electrode portion that has the higher electrical resistance is the disconnection portion and melts or breaks in response to the occurrence of overcurrent.

4. The film heater according to claim 3, wherein
at least a portion of the separated electrode portion has a smaller cross-sectional area intersecting a direction of current flow than the attached electrode portion, and
the portion of the separated electrode portion that has the smaller cross-sectional area melts or breaks in response to the occurrence of overcurrent.

5. The film heater according to claim 4, wherein
the structure is configured as a laminated body in which the conductive film and the pair of electrode sections are laminated in a predetermined order,
at least a portion of the separated electrode portion has a smaller thickness in a lamination direction of the laminated body than a thickness of the attached electrode portion in the lamination direction of the laminated body, and
the portion of the separated electrode portion that has the smaller thickness in the lamination direction of the laminated body melts or breaks in response to the occurrence of overcurrent.

6. The film heater according to claim 4, wherein
at least a portion of the separated electrode portion has a smaller electrode width than the attached electrode portion, and
the portion of the separated electrode portion that has the smaller electrode width melts or breaks in response to the occurrence of overcurrent.

7. The film heater according to claim 3, wherein
a portion of the separated electrode portion is made of a conductive material having a lower electrical conductivity than another portion of the separated electrode portion, and
the portion of the separated electrode portion that is made of the conductive material having the lower electrical conductivity melts or breaks in response to the occurrence of overcurrent.

8. The film heater according to claim 1, wherein
the pair of electrode sections includes an attached electrode portion located in the attached portion and a separated electrode portion located in the separated portion,
at least a portion of the separated electrode portion has a smaller amount of heat transfer than the attached electrode portion, and
the portion of the separated electrode portion that has the smaller amount of heat transfer is the disconnection portion that melts or breaks in response to the occurrence of overcurrent.

9. The film heater according to claim 8, wherein
at least a portion of the separated electrode portion has a smaller surface roughness than the attached electrode portion, and
the portion of the separated electrode portion that has the smaller surface roughness melts or breaks in response to the occurrence of overcurrent.

10. The film heater according to claim 8, wherein
the structure is configured as a laminated body in which the conductive film and the pair of electrode sections are laminated in a predetermined order,
at least a portion of the separated electrode portion is disposed at a position where a flow velocity of airflow that flows around the laminated body is smaller than a flow velocity in a position where the attached electrode portion is disposed, and
the portion of the separated electrode portion where the flow velocity of airflow is smaller melts or breaks in response to the occurrence of overcurrent.

11. The film heater according to claim 1, wherein
the pair of electrode sections includes an attached electrode portion located in the attached portion and a separated electrode portion located in the separated portion,
at least a portion of the separated electrode portion is made of a material having a lower thermal conductivity than a material constituting the attached electrode portion, and
the portion of the separated electrode portion that is made of the material having the lower thermal conductivity is the disconnection portion that melts in response to an occurrence of overcurrent.

12. The film heater according to claim 1, wherein
the structure includes an insulating section having electrical insulation properties,
the insulating section includes an attached insulating portion located in the attached portion and a separated insulating portion located in the separated portion,
at least a portion of the separated insulating portion is made of a material having a lower thermal conductivity than a material constituting the attached insulating portion, and
a portion of the pair of electrode sections located adjacent to the portion of the separated insulating portion that is made of the material having the lower thermal conductivity is the disconnection portion that melts in response to the occurrence of overcurrent.

13. The film heater according to claim 1, wherein
the structure includes an insulating section having electrical insulation properties,
the insulating section includes an attached insulating portion located in the attached portion and a separated insulating portion located in the separated portion, and
at least a portion of the separated insulating portion is made of a material having a higher linear expansion coefficient than a material constituting the attached insulating portion.

14. The film heater according to claim 1, wherein
the separated portion is disposed above the attached portion.

15. The film heater according to claim 1, wherein
the object to be heated is transparent and transmits electromagnetic waves, and
the conductive film is made of a transparent conductive film that transmits electromagnetic waves.
